(19) United States
(12) Patent Application Publication
(10) Pub. No.: US 2024/0428529 A1
(43) Pub. Date: Dec. 26, 2024

(54) METHOD AND SERVER FOR PROVIDING A RULED AUGMENTED REALITY SPACE

(71) Applicant: ARAURA AUGMENTED REALITY FASHION CORP., Montreal (CA)

(72) Inventors: Michael Webber, Montreal (CA); Jesse Cizauskas, New Taipei City (CN); Krzysztof Zielinski, New Taipei City (CN); Connor Harty, Montreal (CA)

(21) Appl. No.: 18/819,259

(22) Filed: Aug. 29, 2024

Related U.S. Application Data
(63) Continuation-in-part of application No. 17/919,042, filed on Oct. 14, 2022.
(60) Provisional application No. 63/535,154, filed on Aug. 29, 2023.

(51) Int. Cl. G06T 19/00

(52) U.S. Cl. CPC G06T 19/006

(57) ABSTRACT

A method for generating a ruled augmented reality platform and associated ecosystem to allow the expressive power of augmented reality to be lived as an overlay onto the physical world and be experienced by a plurality of users in any physical space according to rules. The ecosystem allows for the democratization and facilitation of publishing and adorning via AR to an open platform where users can create, edit, own, view, buy, sell etc. a plurality of unique augmented reality virtual objects and aesthetic or utilitarian design elements. Further, the method allows for simultaneously and specifically managing displaying of design elements in the augmented reality space according to rules which reflect rights, regulations and preferences for displaying these design elements to the users within the confines of a geolocation.

### CROSS-REFERENCE TO RELATED APPLICATION

This application is a continuation-in-part of and claims priority from U.S. patent application Ser. No. 17/919,042, filed Oct. 14, 2022, entitled AUGMENTED REALITY AESTHETIC INTERFACE ECOSYSTEM, published Aug. 3, 2023, under US publ. no. 2023/0245350, which is a national phase of application PCT/CA2021/050916 filed Jul. 6, 2021, entitled AUGMENTED REALITY AESTHETIC INTERFACE ECOSYSTEM, published Jan. 13, 2022, under publ. no. W02022/006661, which claims priority from U.S. provisional patent application 63/048,653 filed Jul. 7, 2021, the specifications of all are hereby incorporated herein by reference in their entirety. This application also claims priority from U.S. provisional patent application 63/535,154, filed Aug. 29, 2023, entitled SYSTEM AND METHOD FOR IMPROVED AUGMENTED REALITY ECOSYSTEM, the specification of which is hereby incorporated herein by reference in its entirety.

### BACKGROUND

### (a) Field

The subject matter disclosed generally relates a system and method for augmented reality virtual-object display policies and management. The present invention further relates to management of classes, features, attributes, real space and virtual space, and display policies and managements in relation with such parameters in an augmented reality ecosystem.

### (b) Related Prior Art

Virtual reality is a computer-generated simulation of an environment (e.g., a 3D environment) that users can interact with in a seemingly real or physical way. A virtual reality system, which may be a single device or a group of devices, may generate this simulation for display to a user, for example, on a virtual reality headset, a smart phone or some other display device. The simulation may include images, sounds, haptic feedback, and/or other sensations to imitate a real or imaginary environment. As virtual reality becomes more and more prominent, its range of useful applications is rapidly broadening. The most common applications of virtual reality involve games or other interactive content, but other applications such as the viewing of visual media items (e.g., photos, videos) for entertainment or training purposes are close behind. The feasibility of using virtual reality to simulate real-life conversations and other user interactions is also being explored.

Augmented reality provides a view of the real or physical world with added computer-generated sensory inputs (e.g., visual, audible). In other words, computer-generated virtual effects may augment or supplement the real-world view. For example, a camera on a virtual reality headset may capture a real-world scene (as an image or video) and display a composite of the captured scene with computer-generated virtual objects. The virtual objects may be, for example, two-dimensional and/or three-dimensional objects, and may be stationary or animated.

An example of such exploration in that field is provided by US patent Application 2018/0096506 in which is described a method which includes sending information configured to render a virtual room on a display device associated with a user, wherein the virtual room comprises a visual representation of the user and a virtual mirror that displays a virtual reflection of the visual representation of the user; receiving a first input from the user selecting a visible feature on the visual representation of the user; presenting one or more alternative options to the user, each of the alternative options corresponding to a variation of the selected visible feature; and receiving a second input from the user selecting a particular alternative option corresponding to a particular variation of the selected visible feature; and causing the visual representation of the user to be modified such that the particular variation of the selected visible feature is implemented.

Some commercial products like TikTok™ provides filters that allow a user to apply such a filter to the image captured by their devices and to share these images to other users. They do not provide augmented reality solutions, but rather simple modifications or processes performed over image or video captured.

Other commercial products such as Pokemon Go™ provide geo-tag-based applications wherein the user moving to a particular location, and the device detecting its presence in a trigger location triggers a game play, an animation, or another type of reward for having reached the destination. Regardless of these products depending in part on reality data for the process and/or for the reward, they do not provide augmented reality solutions.

In parallel, many explorations of online shopping solutions and of transactions of virtual goods such as game-related content have been performed.

Furthermore, like in the physical environment, in augmented reality, there are multiple actors, interests and considerations to consider in order to reach a working ecosystem.

Therefore, needs remain for an augmented reality transactional ecosystem providing the environment for augmented reality assets to be fully valued with respect to the actors and for viewers to have their rights being respected.

### SUMMARY

Accordingly, an augmented reality aesthetic interface ecosystem is provided. The ecosystem provides a looking glass into a futurist world where users express themselves and enhance the visual aesthetics of their world by attaching virtual objects to themselves or to other physical or virtual objects which are made publicly visible to anyone on the platform. The ecosystem consists of an online platform that allows users to create, edit, view etc. a plurality of augmented reality aesthetic design elements. The plurality of design elements may be static or dynamic in nature within an augmented reality space. Further, the plurality of design elements may have any desired shape, size, color, animation etc. and are limited only by the creative capacity of the given user. The plurality of design elements may adorn any real-world or augmented reality item including, but not limited to, a human body, an animal, buildings, vehicles, plant life, other existing augmented reality aesthetic design elements and similar items or any combinations thereof.

According to an embodiment, there is provided a method to generate an augmented reality image comprising a composite view of a physical model and at least one virtual good associated with a user account. The method comprises capturing with a processing device an image of the physical model associated with the user account; generating a digital mapping based on the captured image; generating an augmented reality image; and displaying in real-time the augmented reality image on the processing device. Generating an augmented reality image involves accessing an ownership register listing the at least one virtual good associated with the user account; having a first digital model of a first one of the at least one virtual good; and using the digital mapping to blend the first digital model with the captured image into an augmented reality image. The augmented reality image responds to movements of at least one of the physical model and the processing device.

According to another embodiment, there is provided a method to generate an augmented reality image comprising a composite view of a physical model, a first virtual good and at least a second virtual good. The method comprises capturing with a processing device an image of a physical model associated with a user account; generating a digital mapping based on the captured image; generating an augmented reality image; and displaying in real time the augmented reality image. Generating an augmented reality image comprises having a first digital model of the first virtual good; having a second digital model of the second virtual good; having display preference data used to establish a method of blending the first digital model and the second digital model based on the digital mapping; using the digital mapping to blend the first digital model and the second digital model with the captured image according to the method of blending into an augmented reality image. The augmented reality image responds to movements of at least one of the physical model and the processing device.

According to an aspect, any one of the methods further comprises having display preference data used to establish a method of blending the first digital model with the captured image, wherein the step of generating the augmented reality image comprises determining the method of blending based on the display preference data.

According to an aspect, in any one of the methods the step of blending the augmented reality image comprises establishing interference between the first digital model and the captured image; and resolving the interference according to the display preference data.

According to an aspect, in any of one the methods, the step of having display preference data comprises associating with the first digital model a position data set relative to the digital mapping.

According to an aspect, any one of the methods further comprises defining a plurality of display zones in the digital mapping, wherein said display zone is one of a front zone, a digital mapping zone, and a background zone, and associating one of the plurality of display zones to the first one of the at least one virtual good.

According to an aspect, any of the methods further comprises associating display parameters with the first digital model, wherein the step of generating the augmented reality image comprises displaying an image of the first virtual good based on the display parameters of the first digital model, and wherein the display parameters comprise at least one of a time-based parameter, a position-based parameter, an event-based parameter, and a view-angle-based parameter.

According to an aspect, any one of the methods further comprises having a display policy comprising a viewer profile parameter associated with each one of the at least one virtual good; and determining a viewer profile for a viewer, wherein the viewer profile comprises at least one viewer profile parameter, wherein the step of generating the augmented reality image comprises determining whether or not to integrate the first virtual good in the augmented reality image based on correspondence between the display policy and the viewer profile parameter.

According to an aspect, any one of the methods further comprises evaluating if an ownership status associated with the first virtual good fulfills a requirement, and upon the ownership status failing to fulfil the requirement, preventing at least one of: transferring the first virtual good; modifying the first virtual good; displaying the first virtual good to the user; and displaying the first virtual good to a viewer.

According to an aspect, in any one of the methods the first virtual good is one of a 3D object, a 2D object, an adornment, an aura, a font, a script, an effect, an environmental element, a sound, and a virtual pet.

According to an aspect, one any one of the methods the first virtual good is made of a plurality of combined virtual sub-goods.

According to an aspect, any one of the methods further comprises the user selecting a layering characteristic for a first one of the at least one virtual goods; and the user selecting a second layering characteristic for a second one of the at least one virtual good, wherein the first layering characteristic and the second layering characteristic are structured hierarchically.

According to an aspect, in any one of the methods the digital mapping comprises a plurality of mapping points distributed in a plurality of zones, the plurality of zones comprising at least two of a head zone, a body zone, a halo zone and a vicinity zone, wherein the display preference data comprises an association of at least one of the mapping points located in at least one of the zones with the first virtual good.

According to an aspect, any one of the methods further comprises
detecting the physical model using a viewer device applying an identification method; the viewer device transmitting a viewer profile and an identification of at least one of the physical model and a user account to at least one server; and the viewer device receiving a view authorization from at least one of the one server, wherein the viewer device is adapted to generate the augmented reality image of the physical model; and display the augmented reality image to the viewer.

According to an aspect, in any one of the methods the identification method comprises at least one of: managing a notification; detecting a beacon generated by a user's device; and performing an image recognition process of the physical model.

According to an aspect, in any one of the methods the image recognition process comprises a facial recognition process.

According to an aspect, in any one of the methods the physical model is one of the user's body, the user's head, and a physical object owned by the user.

According to an aspect, any one of the methods comprises associating ownership data with a first one of the at least one virtual good; evaluating the ownership data in association with the first virtual good; and when the step of evaluating the ownership data does not fulfill a requirement, preventing at least one of: transferring the first virtual good; modifying the first virtual good; displaying the first virtual good to the user; and displaying the first virtual good to a viewer.

According to an aspect, in any one of the methods a register stores information regarding at least one of ownership, value history, provenance data, chain of ownership and commoditization of the first virtual good. According to an aspect, the first virtual good has a unique identity and is non-fungible. According to an aspect, the unique first virtual good has a non-fungible encrypted token associated therewith.

According to an embodiment, there is provided a server cluster for managing datasets allowing to transmit data to be used by a personal processing device to display an augmented reality image comprising a composite view of a) a physical model captured by the personal processing device and b) at least one virtual good, wherein the physical model and the at least one virtual good are associated with a user account, the server cluster comprising at least one server comprising a processing unit, a memory and a communication interface. The server cluster is adapted to store a first digital model of a first one of the at least one virtual good each associated with the user account; to store an identification of at least one of the physical model and a device associated with the user account; to store display preference data comprising a blending method of the first virtual good with a captured image of the physical model;—through the communication interface, to receive from the personal processing device identification data generated by an identification method; to retrieve the first digital model from the memory and the blending method associated therewith based on identification data; and to transmit either i) the first digital model and the blending method or ii) the augmented reality image to the personal processing device. The personal processing device is adapted to display in real-time the augmented reality image generated based on the first digital model and the blending method, and wherein the augmented reality image responds to movements of at least one of the physical model and the personal processing device.

According to another embodiment, there is provided a server cluster for managing datasets allowing to transmit data to be used by a personal processing device to display an augmented reality image comprising a composite view of a) a physical model captured by the personal processing device, a first virtual good and b) at a second virtual good, the server cluster comprising at least one server comprising a processing unit, a memory and a communication interface. The server cluster is adapted to store a first digital model of the first virtual good and a second digital model of the second virtual good; to store display preference data comprising a blending method of the first virtual good and the second virtual good with a captured image of the physical model; to receive from the personal processing device identification data generated by an identification method; to retrieve the first digital model and the second digital model from the memory and the blending method associated therewith based on identification data; and to transmit either i) the first digital model, the second digital model and the blending method or ii) the augmented reality image to the personal processing device. The personal processing device is adapted to display in real-time the augmented reality image generated based on the first digital model, the second digital and the blending method, and wherein the augmented reality image responds to movements of at least one of the physical model and the personal processing device.

According to an aspect, any one of the server clusters is further adapted to store display parameters associated with the first digital model, wherein to generate the augmented reality image comprises displaying an image of the first virtual good based on the display parameters of the first digital model, and wherein the display parameters comprise at least one of a time-based parameter, a position-based parameter, an event-based parameter, and a view-angle-based parameter.

According to an aspect, any one of the server clusters is further adapted to store a display policy comprising a viewer profile parameter associated with the first virtual good; to receive a viewer profile of a viewer, wherein the viewer profile comprises at least one viewer profile parameter; and to determine whether or not to transmit the first virtual good based on correspondence between the display policy and the viewer profile parameter.

According to an aspect, any one of the server clusters is further adapted to associate with and to store ownership data of the first virtual good; to evaluate the ownership data of the first virtual good; and if the evaluation of the ownership data does not fulfill a requirement, to prevent at least one of: transferring or accepting transfer of the first virtual good; modifying or accepting modification of the first virtual good; and the first digital model to be transmitted to the personal processing device.

According to an aspect, any one of the server clusters is adapted to store a user account having account parameters associated therewith; to store a viewer account having account parameters associated therewith; to receive identification of the viewer account; to establish a view dataset based on comparison of the account parameters of the user account to the account parameters of the viewer account; to establish a respecting status for each of the first virtual good and the second virtual good based the first virtual good and the second virtual good respecting the view dataset; and to prevent any of the first virtual good and the second virtual good having a negative respecting status to be transmitted.

According to another aspect, an Augmented Space ecosystem, Rules, methods, hardware and software for managing inputs, and generating outputs allowing participation in an audience into the Augmented Space according to the Rules is provided.

More precisely, generation and operation of the Augmented Space ecosystem is based on the existence of three Classes of actors, each having rights and parameters associated therewith. The Rules engine takes into account members of the three Classes such as to be able to provide an Augmented Space comprising a blend of Physical Space and Virtual Space viewable by an audience using AR viewers.

According to an additional aspect, determination of some elements controlling the characteristics of the Augmented Space generated for members of the audience can be managed individually while others are managed according to groups.

According to another aspect, there is provided a method of providing a ruled augmented reality space. The method comprises providing an audience class with a first audience class member having first audience class data; providing an asset class with a first asset class member having first asset class data; providing a display class with a first display class member having first display class data, the first display class member being located in a physical space; providing rules applicable within the physical space; processing the first audience class data, the first asset class data and the first display class data according to the rules to generate a first ruled virtual space; and combining the first ruled virtual space with the physical space to generate a first ruled augmented reality space perceivable by the first audience class member.

The method may further comprise displaying the first asset class member on the first display class member in the first ruled augmented reality space to be perceived by the first audience class member.

The method may further comprise displaying the first ruled augmented reality space to the first audience class member through a first viewer device.

The method may further comprise: providing the asset class with a second asset class member having second asset class data; providing the display class with a second display class member having second display class data, the second display class member being located in the physical space; processing the second audience class data, the second asset class data and the second display class data according to the rules to generate a second ruled virtual space; and combining the second ruled virtual space with the physical space to generate a second ruled augmented reality space perceivable by the second audience class member.

The method may further comprise displaying the second asset class member on the second display class member in the second ruled augmented reality space to be perceived by the second audience class member.

The method may further comprise displaying the second ruled augmented reality space to the second audience class member through a second viewer device.

According to another aspect, there is provided a method of providing a ruled augmented reality space for a plurality of users in a physical space. The method comprises: providing a first register of audience class members, each audience class member being one of the plurality of users, the first register having audience rules; providing a second register of asset class elements, the second register having asset rules; providing a third register of display class elements, the third register having display rules; generating a plurality of virtual spaces using data associated with:
i) the audience class members;
ii) the asset class elements;
iii) the display class elements;
iv) the audience rules
v) the asset rules; and
vi) the display rules; and
combining each one of the plurality of virtual spaces with the physical space to produce a plurality of ruled augmented reality spaces, each one of the plurality of ruled augmented reality spaces being specifically generated to be displayed to a corresponding one audience class member.

The method may further comprise: providing a fourth register of virtual space rules; determining if each one of the plurality of virtual spaces abide by the virtual space rules; and preventing generating one of the plurality of ruled augmented reality spaces for those virtual spaces that do not abide by the virtual space rules.

The method may further comprise registering geolocation data of each audience class member, wherein the processing is further performed based on the geolocations data.

The method may further comprise displaying each one of the plurality of ruled augmented reality spaces on a corresponding one of a plurality of viewer devices worn by the corresponding one audience class member. The displaying may be simultaneous.

The method may further comprise registering orientations of viewing devices of the users, wherein the processing is further performed based on the orientations.

Optionally, at least one display class member is associated with at least one of the audience class members.

The method may further comprise: assembling into a group the audience class members, the group having a group audience rule; and overruling at least one audience rule with the group audience rule during the generating the plurality of virtual spaces.

Optionally, the assembling into a group of a participating member of the audience members may be triggered through a verbal consent from the participating member, a written consent from the participating member, or the participating member entering a geofenced area.

Generating the plurality of virtual spaces may be achieved using a server.

According to another aspect, there is provided a server for providing augmented reality spaces to a plurality of users. The server comprises a processor and a memory storing:
a first register of members of an audience class. At least two members are associated with the plurality of users. The first register stores audience rules therein;
a second register of elements of an asset class. The second register stores asset rules therein;
a third register of elements of a display class. The third register stores display rules therein;
processing code, that when processed, has the processor processing data associated with i) each of the members of the audience class associated with the plurality of users, ii) at least one element of the asset class, and iii) at least one element of the display class, and generating a plurality of virtual spaces; and
a communication interface for receiving identification of the plurality of users from augmented reality viewer devices under control of the plurality of users and also for transmitting one of the plurality of virtual spaces to each of the augmented reality viewer devices for the augmented reality viewer devices to provide to the user one of the augmented reality spaces. Each one of the augmented reality spaces is specific to each one of the plurality of users.

The server may further comprise a plurality of server units interconnected through a network. At least one of the provided registers and at least one of the processes performed are distributed over at least two of the plurality of server units.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a schematic of the ecosystem in accordance with an embodiment;

FIG. 2 is a schematic depicting a process of customizing and activating an augmented reality image of a user in the ecosystem of FIG. 1;

FIG. 3 is a schematic depicting a process through which an augmented reality image of a user becomes available to viewers in the ecosystem of FIG. 1;

FIG. 4 is a schematic depicting zones in relation with augmented reality images;

FIG. 5 is a schematic depicting display areas for virtual goods;

FIG. 6 is a schematic depicting viewer recognizing a user with their personal devices, and viewing the different augmented reality images of the user;

FIG. 7 is a schematic depicting the implementation of display policies in relation with augmented reality images;

FIG. 8 is schematically depicting the process of image capture of a user, digital mapping, combination with virtual goods, and generation of an augmented reality image of the user with virtual goods;

FIG. 9 is an exemplary user interface providing an experience to the user in the ecosystem;

FIG. 10A is a schematic diagram depicting interaction of Classes and Rules Engine;

FIG. 10B is a schematic diagram depicting application of Classes Rules, including rights and policies, and negotiation of the applying of these Rules by a Rule Engine;

FIG. 11 is a schematic diagram depicting management of Classes and opt-in/opt-out options in relation to Groups;

FIG. 12 is a block diagram depicting process involved in providing participation in the Augmented Space Ecosystem through different Augmented Spaces;

FIG. 13 is a block diagram depicting process involved in providing participation in the Augmented Space Ecosystem through different Augmented Spaces when considering Groups;

FIG. 14 is a block diagram depicting process and data involved in providing participation in the Augmented Space Ecosystem;

FIGS. 15A and 15B is a list showing examples of data associated with members of Classes;

FIG. 16 is a block diagram depicting parallel processing of Augmented Spaces of Group-participating individuals and Opt-out individuals; and

FIG. 17 is a representation of an Augmented Reality ecosystem, comprising a server and a plurality of Augmented Reality Viewers under control of individuals.

It will be noted that throughout the appended drawings, like features are identified by like reference numerals.

### DETAILED DESCRIPTION

The realizations will now be described more fully hereinafter with reference to the accompanying figures, in which realizations are illustrated. The foregoing may, however, be embodied in many different forms and should not be construed as limited to the illustrated realizations set forth herein.

With respect to the present description, references to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

In the following description, it is understood that terms such as “first”, “second”, “top”, “bottom”, “above”, “below”, “front”, “rear” and the like, are words of convenience and are not to be construed as limiting terms.

In the following description, the terms “choose”, “select”, “pick”, etc. in relation with a user are intended to be construed as an action of a user resulting in data in the ecosystem.

It will be noted that throughout the appended drawings, like features are identified by like reference numerals.

### Lexicon

In the present context, a Class should be understood to be a type of a Tangible Actor involved in the presentation or not of augmented reality assets.

A Tangible Actor should be understood as a physical or tangible component or device under control of, owned, or used by an Entity, e.g., an individual or a company, that has interests and is able to express interests or perform actions in relation with the Tangible Actor.

An Entity should be understood as an individual or a company, having interests and able to express interests or perform actions in relation with a Tangible Actor.

Audience Class should be understood as a Class having members having a perception-related function.

Display Class should be understood as a Class having members having a display-related function.

Asset Class should be understood as a Class having members having a function related to the generation and display of a Virtual Asset in Augmented Space.

Rules should be understood as methods, programs and/or algorithms used to determine outputs for the operations of the Augmented Space taking into account parameters associated with Tangible Actors and Classes of the Tangible Actors.

Rights and Parameters should be understood as inputs, e.g., decision-making values and information, thus variable parameters provided through e.g., databases and/or invariable parameters, e.g., hardcoded data, used by Rules or other processes to generate outputs.

Physical Space should be understood as the physical environment or tangible environment in which Tangible Actors exist.

Overlayable Space should be understood as a portion of the Physical Space that is determined to be able to be an object of an overlay or of blending according to another method with a virtual Asset such that an Augmented Space is generated thereby.

Virtual Space should be understood as an information-based space in which Virtual Assets can be put into existence.

Augmented Space should be understood as an environment comprising part of the Physical Space and associated Virtual Space added thereto, e.g., overlaid thereto so that, through that process an Augmented Space comprising Physical Assets and Virtual Assets can be combined and are accessible, e.g., perceptible, to users using a device, also known as Augmented Reality viewing device or AR viewer such as AR glasses.

Physical Asset should be understood as an asset part of the Display Class existing in the Physical Space.

Virtual Asset should be understood as an asset part of the Asset Class existing in the Virtual Space.

It is to be noted that for the present document, processes involved in the generation of Virtual Assets, validation and publication of Virtual Assets in sense of selling, exchanging, giving, or other types of distribution are considered peripheral to the present description, and are more detailed in, for example, patent application No. U.S. 17/919,042, published under No. U.S. 2023/0245350 A1, entitled AUGMENTED REALITY AESTHETIC INTERFACE ECOSYSTEM owned by the present Applicant, and incorporated herein by reference.

Cluster Server(s) and backbone server(s) should be understood as a combination of software and hardware comprising one or more servers that operate as one virtually combined server in terms of physical and operable capabilities, regardless of the physical distance between them and the communication method through which they exchange signals and data.

Operating System should be understood as a software offering an operating layer between hardware, e.g., server hardware, and programs and data allowing to perform the programs, maintain and exchange data, and generate outcome results in an intended fashion.

Register, also known as rights management register, should be understood as one or more databases, e.g., distributed database, where is stored and managed data relative to rights associated with Tangible Actors, Classes, Assets, etc. such as certificate of authenticity and ownership, provenance and chain of ownership, and digital ledgers, to list a few.

Augmented Reality Mixer should be understood as a technology (hardware and software) that allows generating and distributing Virtual Space so that through an AR viewer, Augmented Space is perceptible to one or more Tangible Actors of the Audience Class, where the perceptible Augmented Space of each one of the Tangible Actors of the Audience Class is the result from an Augmented Reality Rendering process, also known as AR rendering.

The viewer, or AR viewer, operated by Tangible Actors and members of the Audience Class, is the device or technology, (hardware and software) allowing the users, also known as the Tangible Actors, to view the Augmented Space. Without limitations, Augmented Spaces are typically provided though personal devices such as computers and other smart devices such as smart phones and smart glasses.

The Augmented Space Ecosystem, also known as Augmented Reality Space Ecosystem, or AR Space Ecosystem, should be understood as the ecosystem generated therethrough, comprising an ensemble of the complex and numerous perceptible Augmented Spaces each resulting from an AR Rendering, wherein the virtual spaces are perceivable by numerous audiences, and wherein the virtual spaces are constructed over parts of a common Physical Space.

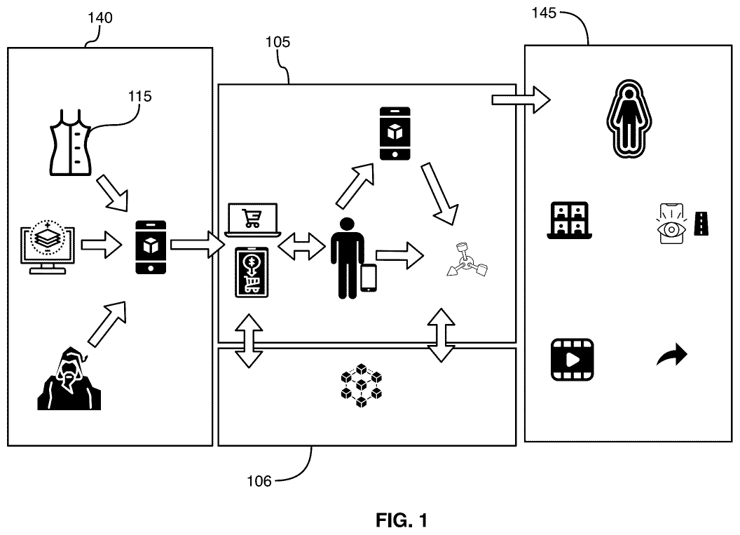

Referring to FIG. 1, in realizations there are disclosed augmented reality ecosystem comprising content providers, a content publishing solution, a marketplace, one or more backbone servers assembled in a centralized or preferably a decentralized server cluster, an augmented reality mixer and an augmented reality viewer.

FIG. 1 depicts schematically a representation of the augmented reality ecosystem with functional relationship between them, comprising a cluster server 140 in communication with processing devices 105 operating software 106 to configure and generate augmented reality images in the Augmented Space Ecosystem 145.

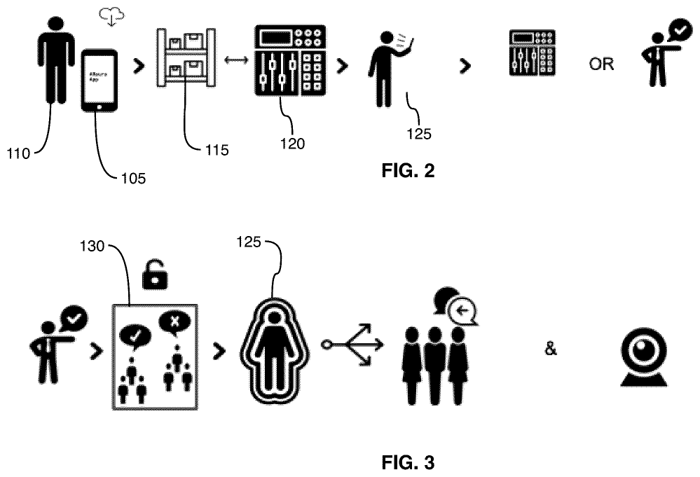

FIG. 2 depicts the process of a user adorning an augmented reality aura. The process comprises a user 110 of a personal device updating the content of the personal device 110 with a collection of virtual goods 115. It comprises customizing 120 the augmented reality with potentially multiple virtual goods 115, to validate the customization or change the customization or register the customization 125 to be live, in other words to be used to show the virtual goods 115 in an augmented reality view.

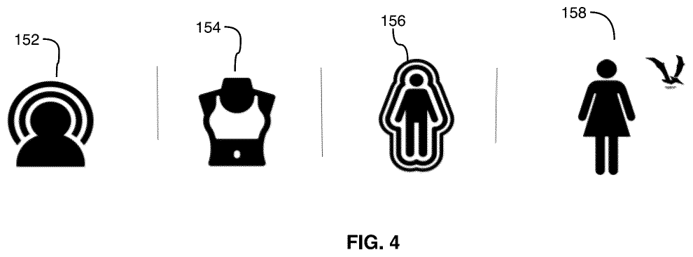

FIG. 3 depicts the process to go live, from the step of setting permissions 130 in the system, to go live 125. In a social augmented reality, the process comprises notifying nearby members of the Augmented Space Ecosystem 145 (FIG. 1) and allowing the augmented reality view to be broadcasted via webcam.

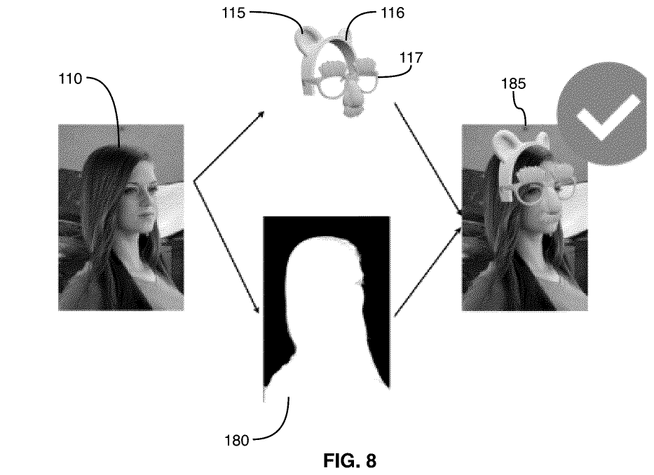

FIG. 7 depicts the process of managing rights 130 to individual and/or groups whereby a user broadcasts multiple augmented reality versions, and wherein based on user data, view data and correlation between the data (e.g., member of a same group), a particular augmented reality version is displayed to a viewing user while another augmented reality version is displayed to another viewing user having different data associated therewith. For example, viewing users of Group A may see version A while viewing users of Group B see version B of the augmented reality of the user.

One should understand from the description before that rights, user accounts, and other information are registered, centrally managed, authenticated, compared, and/or broadcasted in order for some information to be broadcasted or transmitted to particular viewer devices while preventing the same information to be broadcasted or transmitted to other viewer devices. It should also be understood that the information may be tailored to viewing user(s) or group of viewers based on viewer information, rights and/or display rights.

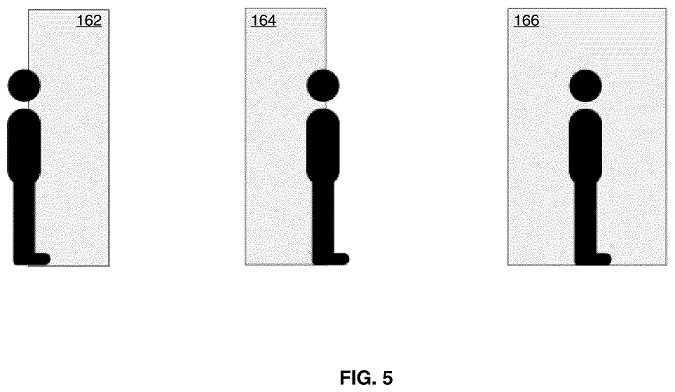

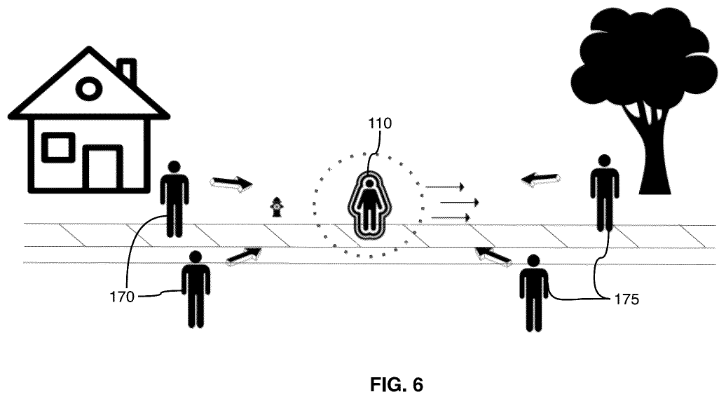

In augmented reality views, the virtual goods are particularly designed to be displayed in one of four display zones (see FIG. 4) comprising a head zone 152, a body zone 154, a halo zone 156 and an environmental zone 158, wherein one or more areas (see FIG. 5) may be associated with each of the zones 152, 154, 156 and 158.

The head zone 152 is defined around the head of the user, wherein the virtual good(s) is displayed covering at least a portion of the head of the user. Examples comprise a crown covering the top of the head, a virtual tattoo covering a portion of the visible skin, and a helmet covering the totality of the head, both according to a front view, a side view, and a rear view of the user.

The body zone 154 is defined similarly to the head zone 152 but refers to body parts below the chin of the user.

The halo zone 156 is defined as a virtual space at a set distance, aka vicinity area, from the head or body of the user wherein custom surrounding(s) may be set.

Environment zone 158 consists of the space viewable by the camera that is outside the other zones listed before. Environment zone 158 is ideal for displaying, for example a pet or other animation with no or limited interaction with the user.

The virtual goods are further divided into two categories: virtual items and customizations.

The virtual items are designed self-standing virtual goods to be displayed according to one or more areas, that is in a spatial relationship to the user (see FIG. 5), typically to be displayed to appear in the front area 162 in front of the user, in the rear area 164 behind the user or the surrounding area 166 surrounding the user. Typically, multiple virtual goods may be placed onto a user for each area and different effects may be utilized per area. The present solution also provides a capability for blending between areas so that virtual goods can overlap and utilize transparencies. Any object mapped onto any of the four areas 152, 154, 156, and 158 may go into any of the areas 162, 164, and 166.

Customizations are additions and modifications to virtual items and/or users. For instance, changes in color, effects varying based on time, viewing angle, position, etc. are such customizations. All virtual goods that are not self-standing but rather effects and/or other kind of enhancement, customization, or adornment of a virtual item and/or the user thus falls into that category.

The present environment allows to concurrently use a plurality of virtual items, customizations and/or a mix of one or more of the two types for a user to provide the desired adornment to their image in the augmented reality.

According to embodiments, customizations may have trigger(s) associated therewith, e.g., a wink of the user, resulting in the customization being initiated, ended, or moving to another phase (or configuration or parameter) upon detection of the trigger.

Therefore, the present solution may be described as a method to generate an augmented reality image comprising a composite view of a physical model, usually a user, and at least one virtual good, usually associated with a user account. The method comprises capturing with a processing device an image of the physical model (associated with the user account); generating a digital mapping based on the captured image; generating an augmented reality image; and displaying in real-time the augmented reality image on the processing device. Accordingly, the method allows to display an augmented reality image or video that responds to movements of at least one of the physical model and the processing device.

According to a realization, generating an augmented reality image comprises accessing an ownership register listing the at least one virtual good associated with the user account; having a first digital model of a first one of the at least one virtual good; and using the digital mapping to blend first digital model with the captured image into an augmented reality image. Such register may be stored on the cloud, on a server cluster comprising one or more servers having hard drive(s) to provide access and respond to requests of devices using virtual goods in the present augmented reality, aka Augmented Space Ecosystem.

According to a realization, generating an augmented reality image comprises having a first digital model of a first virtual good; having a second digital model of a second virtual good; having display preference data used to establish a method of blending the first digital model and the second digital model based on the digital mapping; and using the digital mapping to blend the first digital model and the second digital model with the captured image according to the method of blending into the augmented reality image to be displayed.

It is to be noted that the term “blending” refers to the process of combination and/or concurrent usage of the virtual goods toward a common result. Therefore, blending may involve, without being limited to, the visual rendering of the virtual goods. However, blending may involve non-visual characteristics of the virtual goods, for example with virtual goods falling in the customization category.

The described method contemplates having display preference data used to establish a method of blending the first digital model with the captured image, wherein the step of generating the augmented reality image comprises determining the method of blending based on the display preference data. It may comprise establishing interference between the first digital model and the captured image; and resolving the interference according to the display preference data. It may comprise associating with the first digital model a position data set relative to the digital mapping.

The described method further contemplates having a plurality of display areas in the digital mapping, wherein the display areas comprise a front area, a digital mapping area of the surface of the physical model, and a background area, and associating at least one of the display areas to the virtual goods.

The method may comprise associating display parameters with the digital models, wherein the step of generating the augmented reality image comprises displaying an image of the first virtual object based on the display parameters of the first digital model, and wherein the display parameters comprise at least one of a time-based parameter, a position-based parameter, an event-based parameter, and a view-angle-based parameter. An example of a model with time-based parameters may be a model displayed differently over time. An example of model with position-based parameters or the model changing is display characteristics when moved from a first position to another. An example of model with event-based parameters may be a model displayed only after occurrence of an event, a trigger, controlled by the user, e.g., a wink. An example of model with event-based parameters may be a model displayed differently based on the position of the camera capturing the image relative to the model.

The described method also contemplates having a display policy comprising a viewer profile parameter associated with the virtual goods; and determining a viewer profile for a viewer, wherein the viewer profile comprises at least one viewer profile parameter. Accordingly, the step of generating the augmented reality image comprises determining whether or not to integrate a virtual good in the augmented reality image based on correspondence between the display policy and the viewer profile parameter.

The described method also contemplates evaluating if an ownership status associated with a virtual good fulfills a requirement, and upon the ownership status failing to fulfill the requirement, preventing at least one of: transferring the virtual good; modifying the virtual good; displaying the virtual good to the user; and displaying the virtual good to a viewing user.

The described method also contemplates virtual goods such as but not limited to a 3D object, a 2D object, an adornment, an aura, a font, a script, an effect, an environmental element, a sound, and a virtual pet. It therethrough contemplates that virtual goods are any virtual object and aesthetic or utilitarian design that can be attached to any real world or virtual objects and aesthetic or utilitarian design element. It is to be noted that virtual goods may be made of a plurality of combined virtual sub-goods.

The described method also contemplates the user selecting layering characteristics for the virtual goods, wherein the layering characteristics are structured, managed and applied hierarchically.

The described method also contemplates digital mapping comprising a plurality of mapping points distributed in a plurality of zones. The plurality of zones comprising for the example of a user a head zone 152 (FIG. 4), a body zone 154, a halo zone 156, and a vicinity zone 158, wherein the display preference data comprises an association of at least one of the mapping points located in at least one of the zones with the virtual good to be part of the augmented reality image.

The described method also contemplates a viewing user detecting the physical model using a viewer device, e.g., a smart phone or smart glasses, and applying an identification method; the viewer device transmitting a viewer profile and an identification of at least one of the physical model and a user account to at least one server; the viewer device receiving a view authorization from at least one of the one server, wherein the viewer device is adapted to: generate the augmented reality image of the physical model and to display the augmented reality image to the viewing user. Thus, an augmented reality version of the user may be seen by the viewing user. The identification method may comprise managing a notification; detecting a beacon generated by a user's device; and/or performing an image recognition process of the physical model. The image recognition process may consist in a facial recognition process when the physical model is a user.

The described method also contemplates the physical model being one of the users, the user's body, the user's head, and a physical object owned by the user such as a car, a building, or even an item of clothing worn by the user. It also contemplates any number of real-world goods, for example a shirt in a retail store (owned by the manufacturer, for example, Adidas™), a bottle of Coke™ (identified, for example, by a QR code), a display stand/section on a shelf, or urban furniture (for example, a bus stop, a park bench).

The described method also contemplates having a register that stores information regarding at least one of ownership, value history, provenance data, chain of ownership and commoditization of the virtual goods. A non-fungible token may be associated with the virtual goods, thereby ensuring that the virtual goods cannot be duplicated. The non-fungible token may be encrypted.

It is herein contemplated that the non-fungible tokens allow to manage ownership over different devices associated with a user account (typically stored and manager on the cloud) of the user owning the virtual good. It allows to have every virtual good managed as an individual item even amongst a set of like items, e.g., tooth of a virtual good comprising 100 orc teeth).

It further allows to have and manage an open marketplace wherein creators and curators may offer, sell, and lease virtual goods. Such a marketplace may thus be a central hub for all distribution and exchange of virtual goods. The marketplace may further provide tools for importing virtual goods from other sources, such as games, in the Augmented Space Ecosystem, whereby, for example, a person may wear in the Augmented Space Ecosystem the same outfit as their alias wears in a game played by the user.

Such tools may comprise a method for automating a mapping process for fitting virtual goods to people (aka an Artist tool standard), when the source code of the virtual good is initially defined in another environment, e.g., a game.

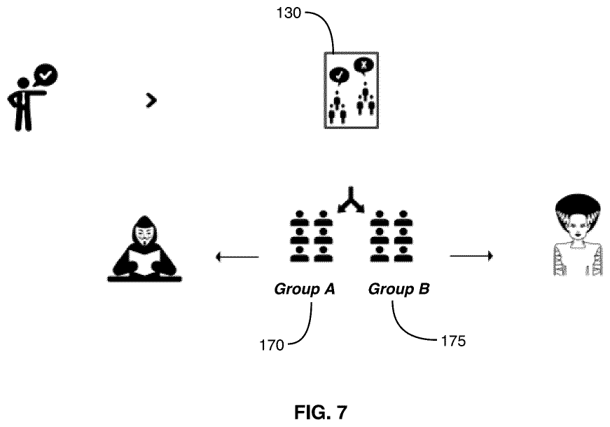

Referring to FIGS. 1 and 4 and referring additionally to FIGS. 6 and 7, the present solution and associated Augmented Space Ecosystem allows to see a user according to a particular aura, aka an augmented reality image based on a blending of virtual goods and a captured image of the user based on digital mapping of the user, wherein the augmented reality image is authorized by the user. For instance, as illustrated on FIG. 6, the viewing users 170 on the left side see a first augmented reality version of the user 110, while the viewing user 175 on the right side see a second augmented reality version of the user 110 that includes a halo since the viewing devices display the image of the user according to viewers' account data and user's display policies. According to data, the first augmented reality version may comprise no, one or more virtual goods while the second augmented reality version may comprise from none, one or more virtual goods common to the first augmented reality image.

Accordingly, the system uses display policies comprising viewer profile parameters associated with each of the virtual good and the second virtual good to determine a viewer profile for a viewing user, wherein the viewer profile comprises at least one viewer profile parameter. The step of generating the augmented reality image thereby comprises determining whether to integrate the first item and the second item in the augmented reality image based on correspondence between the display policy and the viewer profile parameter.

Referring back to FIG. 7 for illustration, display policies allow to segregate the viewing users in groups 170 and 175, wherein the augmented reality images of oneself available to viewing user of a first group 170 are different than the augmented reality images available to the views of the second group 175.

To perform such a process, the system is adapted for identifying the physical model, e.g., user, using a viewer device; the viewer device transmitting a viewer profile and a user identification to a server cluster; and the viewer device receiving data from the server cluster necessary to generate and display in real-time the augmented reality image associated with the user identification that respects the viewer profile. Thus, the augmented reality image responds to movements of at least one of the physical model, e.g., user, and the viewer device.

Therethrough, the system provides augmented reality images of a user to himself and to others, aka viewing users, wherein the user controls the images they allow to be seen.

The method is used to generate an augmented reality image, and further to generate a series of images where each image is based on a capture of a user and thereby allows the series of images to follow the movement of the user of the view.

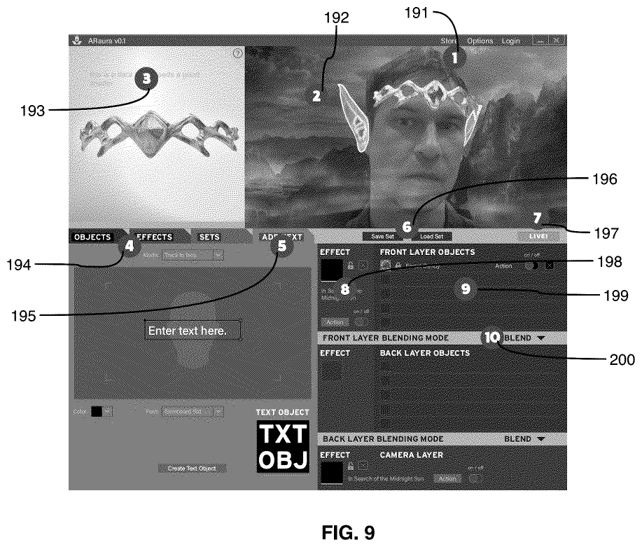

As depicted on FIG. 8, to perform a segmentation process based on an image capture of the physical model, e.g., a user, through a camera. The segmentation process recognizes a physical model, in the present example the user 110 and the silhouette of the user 110. In other words, the system defines a (negative) digital 3D mapping 180, so that the software can make objects appear behind them. When the camera image is blended with the virtual goods 115, the software sets a depth for the extracted segments regarding the content of the other layers and calculate therefrom an occlusion value used to generate the augmented reality image 185.

It should be noted that the recognizing of the human silhouette may be, and more precisely, is preferably combined with a pose estimation algorithm to establish a facing direction of the user relative to the image capture camera, to orientate the virtual objects, or more precisely the digital 3D models of the virtual objects accordingly. Thereby, it allows determining the parts of the virtual objects that should be visible and the ones that should be hidden. For instance, the image on FIG. 8 depicts a first virtual good 116 and a second virtual good 117 to be displayed in the head zone, wherein the layering and the blending of the virtual goods 116 and 117 result in the first virtual good 116 hiding a portion of the second good 117, and parts of both the first virtual good 116 and the second virtual good 117 being hidden by the image of the user.

It should be noted that the software allows to customize the layering and/or blending of the virtual goods. In the example depicted on FIG. 8, another user who would own the first object and the second object may decide to structure the hierarchy of the layer opposed to the one depicted; what would result in the arm of the glasses (virtual good 117) being partially hidden behind the virtual good 116.

The software allows to generate and process simple and complex virtual goods. Complex objects may for instance be made of multiple elements (aka sub-goods) or individual virtual goods assembled according to overlaying and/or blending parameters. Once combined, a complex virtual good may be processed like a simple (opposed to complex) virtual good, allowing to associate similar parameters therewith. Some complex virtual goods may all take place in the same zone, or alternatively be displayed to cover/enter at least partially in at least two zones.

Referring to FIG. 6, the augmented reality experience may be divided in two types of experiences: a user experience and a viewing user experience.

The user experience comprises setting display preference data comprising association of zones, areas, hierarchy for layering, and other parameters used to set the way the objects will be displayed. The user experience also comprises to set display policy comprising viewer profile parameters associated with each of the items, whereby the system determines whether to integrate items in the enhanced digital 3D model based on correspondence between the display policy and the viewer profile parameter.

The experience of the viewing user consists essentially in detecting the user using a viewer device; the viewer device transmitting a viewer profile and a user identification to a server; the viewer device data necessary to generate and display in real time the augmented reality images on the viewer device that respect the viewer profile.

It should be noted that the augmented reality image used herein refers also to an animation, video and/or sequence of augmented reality images that relate to the same physical model, e.g., user. The process for generating and displaying augmented reality images and videos are typically performed live, in real time, which results in any of the physical model/user and/or the viewing user moving resulting in live modifications of the images or video displayed to the viewing user. In other words, the system responds live to relative movements of the physical model (e.g., user) and the viewing user.

It is worth noting that the previous examples exploit the user as both the person managing the adornment configuration through which virtual objects are blended to a physical model and also the physical model. In other realizations, the user may associate virtual goods to be blended to a different physical model, e.g., a building or a car, for which the user owns the customization rights. Thus, in the latter exemplary case, the user may register a building to an account, and apply virtual goods (e.g., fonts and effects) to the building so that viewing users passing by the building would see through their smart device the augmented reality version of the building, which may change based on the viewing angle of the viewing device relative to the building.

It is also worth noting that the present description contemplates therethrough the display of augmented reality images of the user of a smart device or a desktop with a camera, regardless of the person in front of the camera having an augmented reality version of themselves displayed is the owner of the use account. Thus, in cases the user is also the viewing user while in other cases some or all viewing users may be distinct from the user.

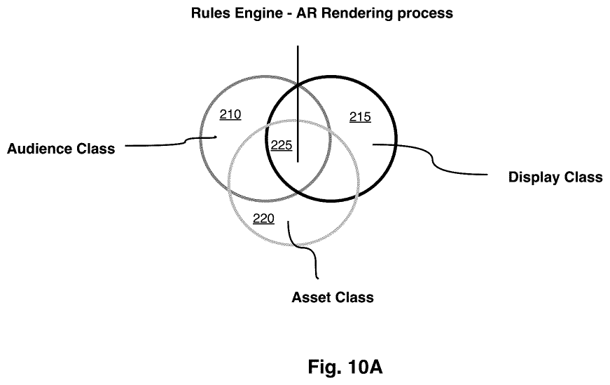

Referring now to FIG. 9, it provides an exemplary user interface (UI) for a user to customize their augmented reality image.

A server cluster 140 (FIG. 1) comprising one or more backbone server(s) that are potentially operating in a decentralized manner through tasks distribution procedure such as remote procedure calls), not depicted on FIG. 6, is in communication through, e.g., Internet, with a user device and a viewer device, The server cluster is adapted to provide the user experience and the viewing user experience. The UI of a e.g., desktop computer, comprises a link 191 to a store where users can buy more objects and effects for their collection. Area 192 is a space for a video feed augmented reality images. Area 193 a is digital clothing item card with item rarity displayed by color code at bottom. Item blurb and/or artist information is provided on the back. Area 194 is to display user's collection of digital clothing objects and effects. A custom text tool 195 allows creation of text objects overlaid on video feed. A set management tool 196 is provided so that outfits can be saved. Control 197 allows to go live and thereby activate on the ecosystem. Tool 198 allows having effects being dragged to a forward or backward layer. They can be turned On and Off, locked, or removed here. Effects with actions are activated using control 198. Area 199 is where objects are separated into front and back layers to control how an outfit looks. Individual objects can be locked, turned On/Off, or removed in area 199. Objects with actions are further activated in area 199. Control 200 is a control to enter a layer blending mode so that objects effects fit well together visually.

Exemplary UI on a mobile device such a smart phone (not depicted) typically comprises most of the elements of the UI described before, and further comprises a notification, localization, recognition, and viewer components allowing a viewing user to view another user through augmented reality images, wherein the augmented reality images are enhanced videos of the video capture of the user enhanced with the described virtual items.

It is worth noting that the term recognition and other processes related thereto may involve one or more methods and/or technologies comprising: facial recognition, beacon technology, QR code, body recognition Bluetooth™ permissions &/or any other means to recognize the user.

It contemplates the identification method may involve any of the following technologies: PINs, or QR codes, RF ID's (Radio Frequency ID) and NFC's (Near Field Communication) or custom image recognition alone or in conjunction with facial recognition (particularly during the pandemic).

The server cluster manages datasets allowing a personal processing device to generate and display augmented reality images comprising a composite view of a) a physical model captured by the personal processing device, b) virtual goods. The server cluster comprises at least one server comprising a processing unit, a memory, and a communication interface. The server cluster is adapted to store a first digital model of the virtual goods each, e.g., associated with the user account; to store an identification of at least one of the physical model and a device associated with the user account; to store display preference data comprising a blending method of the virtual goods with a captured image of the physical model; to receive from the personal processing device identification data generated by an identification method; to retrieve the digital model and the blending method associated therewith based on identification data; and to transmit the digital model and the blending method to the personal processing device.

It is herein contemplated that the server cluster may be adapted to store display parameters associated with the digital model, wherein to generate the augmented reality image comprises displaying an image of the virtual good based on the display parameters of the first digital model, and wherein the display parameters comprise at least one of a time-based parameter, a position-based parameter, an event-based parameter, and a view-angle-based parameter.

It is herein contemplated that the server cluster may be adapted to store a display policy comprising a viewer profile parameter associated with the first virtual good; to receive a viewer profile of a viewing user, wherein the viewer profile comprises at least one viewer profile parameter; and to determine whether or not to transmit the first virtual good based on correspondence between the display policy and the viewer profile parameter.

It is herein contemplated that the server cluster may be adapted to associate with and to store ownership data of the first virtual good; to evaluate the ownership data of the first virtual good; and if the evaluation of the ownership data does not fulfill a requirement, to prevent at least one of: transferring or accepting transfer of the first virtual good; modifying or accepting modification of the first virtual good; and the first digital model to be transmitted to the personal processing device for the first virtual good to be viewed or manipulated in any way on a personal processing device.

It is herein further contemplated that the user account has account parameters associated therewith, wherein the server cluster is adapted to store a viewer account having account parameters associated therewith; to receive identification of the viewer account; to establish a view dataset based on comparison of the account parameters of the user account to the account parameters of the viewer account; and to identify a respecting one of the at least one virtual good associated with the user account that respects the view dataset, wherein the first digital model is of the respecting virtual good.

It is herein contemplated that the server cluster may store security credentials and security keys, and wherein the server cluster is adapted to combine security keys queried from its memory and received from the personal processing device and to compare the combined key with the security credentials to identify the virtual good.

It is herein contemplated that the server cluster may be adapted to store a plurality of user accounts, each associated with a user identification and account parameters. The cluster server is adapted to receive data allowing to establish a user account, and to retrieve or generate data used to generate augmented reality images based on the identification of the virtual goods associated with the account parameters of the identified user account.

It is herein contemplated that the server cluster may be adapted to receive data allowing the processing unit to establish a user account of a user and a user account of a viewer among the plurality of user accounts. The server cluster is adapted to generate or retrieve data used to generate augmented reality images based on comparison of the account parameters of the user account with the account parameters of the viewer account to establish a view dataset; and to identify the virtual goods that are associated with the user account with respect to the view dataset.

According to realizations and available processing power of the personal processing devices, the carry out of the method when sharing augmented reality images to a viewing device may require almost no P2P (person-to-person) processing (when all or almost all information and processing is performed on the cloud by the server cluster) to a great level of P2P processing (when the personal processing devices, e.g., exchange information directly with each other, exchange virtual goods, blending methods, rights, etc., directly to each other, and/or generate pre-processing, processing or post-processing for the other device). Other exemplary processes that may involve P2P include detection of a physical model or a personal process device and identification or recognition of a user.

Therefore, it is contemplated that at least some of the steps of the present method and embodiments may be performed according to on-the-cloud protocols and/or P2P protocols based on e.g., characteristics of the environment (network speed for data transmission, processing power, etc.) and design considerations.

It should be remembered that the ecosystem comprises a marketplace allowing artists and creators to create, sell and modify virtual goods. The register is designed to store and maintain a database of the virtual goods certificates, and associate rights to transfer, modify and display to themselves or on a viewing user's device an augmented reality image comprising one or more of the virtual goods owned.

More precisely, the register maintains rights that permit to follow the ownership of a virtual goods over its life. Some rights that may be associated with an virtual good may include exclusive right versus right to transfer and/or resell the virtual good (with or without creative fees associated with the reselling), the right of the virtual good to remain unchanged, in other words integrity rights, versus rights for the current owner to modify the virtual good, try period rights during which the virtual good is temporarily transferred to a user and automatically removed from its collection when the try period has elapsed. Rights may also include private collection, in which the virtual good may not set to be visible by viewing users on their own devices, versus public wherein the object may be set to take part of an augmented reality image visible by others.

Accordingly, the described innovation provides a complete augmented reality platform and associated ecosystem that allows the expressive power of augmented reality to be live as an overlay onto the physical world and be experienced by a plurality of users in any physical space. The ecosystem allows for the democratization and facilitation of publishing and adorning via augmented reality to an open platform where users can create, edit, own, view, buy, sell, etc. a plurality of unique augmented reality virtual objects and aesthetic or utilitarian design elements. Further, the ecosystem allows for any users participating in the ecosystem to integrate one or more of the plurality of their purchased design elements into their daily real-world experiences. Additionally, the ecosystem provides a means for expanding the existing marketplace for goods and services into the augmented reality space.

### Processing of the Augmented Space Ecosystem Based on Classes

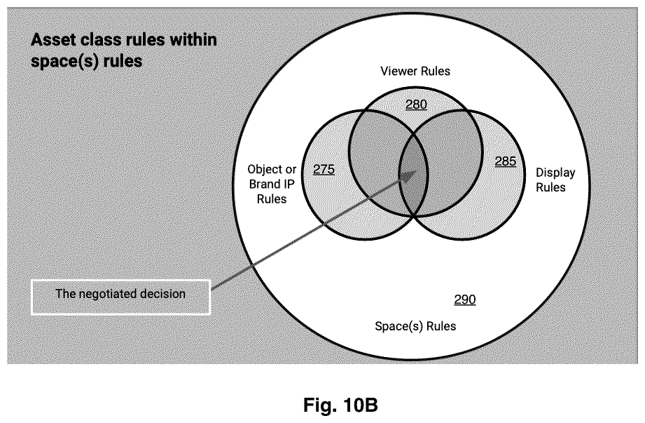

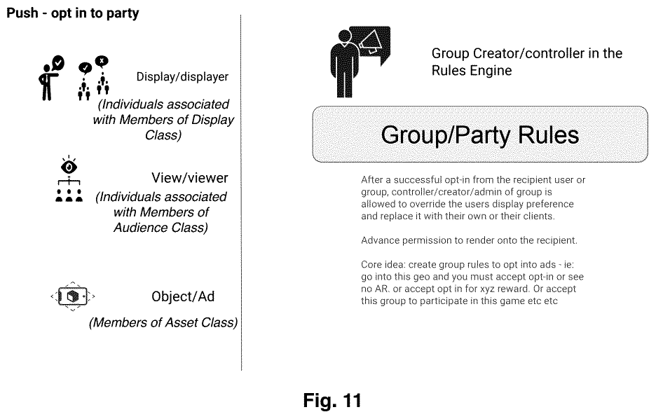

Referring now to FIG. 10A, the determination of the operations in the Augmented Space Ecosystem can be schematically depicted through the definition of Tangible Actors according to three Classes:
a) Audience Class 210, used to manage the rights and parameters of users (typically individuals) associated with an AR viewer, that, alone or as a group, are using AR viewers to perceive an Augmented Space;
b) Display Class 215, used to manage rights and parameters associated with a portion of the Physical Space, also known as an Overlayable Space, that may be overlaid or otherwise combined with a Virtual Space to provide an Augmented Space encompassing that Overlayable Space. Examples of Overlayable Space may be static or absolute, such as a physical wall, or relative such as the body of an individual that is moving in the Physical Space with the individual; and
c) Asset Class 220, used to manage rights and parameters associated with a Virtual Asset such as virtual ads, virtual brand representations, virtual embellishments, etc., including code used for the perceptible version of the Virtual Asset generated through the AR Rendering.

Accordingly, Rules 225 are the processes based on which operates an Operating system to determine the nature of what is generated through an AR Rendering for each member of the Audience Class, including what Virtual Asset takes part of which Augmented Space(s) and the Overlayable Space(s) involved in the generation of the Augmented Space(s) to be provided to viewer(s) managed according to an Audience Class.

For example, Execution of the Rules may result in determining at an exemplary time that a first AR Viewer operated by a first individual (Audience Class) is rendered an Augmented Space comprising a brand representation (Asset Class) on a wall (Display Class), while a second viewing device operated by a second individual (Audience Class) located next to the first individual is rendered an Augmented Space comprising an Embellishment (Asset Class) viewable over the body of a third individual (Display Class) travelling in front of the same wall (Display Class).

Such determination of the resulting Augmented Spaces part of the same Augmented Space Ecosystem is performed by an Operating System that performs based on the Rules and on data associated with all entities stored in one or more Registries according to their Classes in relation with the situation, determining for example:
i) the rights and parameters associated of the individuals, that is audience or members of the Audience Class, to view some Virtual Assets or be excluded from seeing the Virtual Assets according to parameters associated with, for example, the involved members of the Asset Class, with examples of rights and parameters being targeted audiences, targeted time period distribution, limited number of publications allowed, etc.;
ii) the rights and parameters associated with Overlayable Spaces that are members of the Display Class, with examples of rights and parameters being allowed, not allowed, commissioned, private, static, relative, publication schedule, part of a group, open, etc.; and
iii) the rights and parameters associated with the Virtual Assets members of the Asset Class, with examples of rights and parameters being ownership, renting, audience age restriction, geographical Physical Space restrictions, time schedule restrictions, life cycle, etc.

Referring to FIG. 10B, it is depicted that the Rules are associated with each of the Classes, specifically Object Rules 275, Viewer Rules 280, and Display Rules 285. The process takes place within a space having Space Rules 290. Generation of an AR space requires to determine acceptable conditions according to the Rules 275, 280, 285, 290, and sometimes negotiations of the Rules when conflict arises to minimize the conflicts between the Rules and the applying of the Rules in the AR space. It is worth mentioning that some rules (such as Space Rules 290) may trump other Rules, with the negotiation being performed with consideration of such a hierarchy.

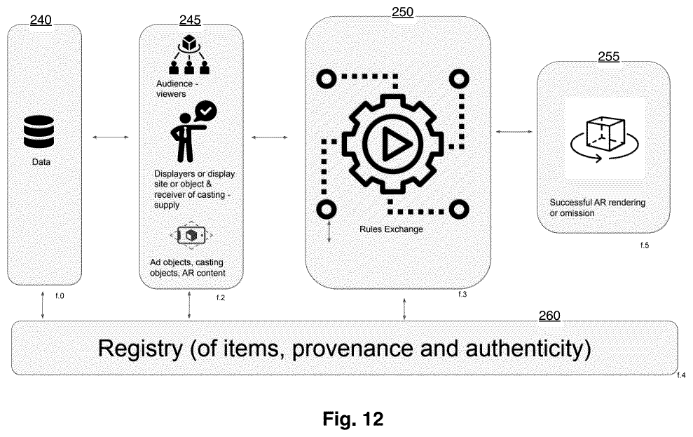

Referring to FIG. 11, it is schematically depicted that the rights registered in association with members of Audience Class may be at least partially commonly managed as members of an Audience Class being part of a Group, and thus having some similar parameters fed to the Rules to determine the Augmented Space of each individual part of the Group.

It is to be noted that the notion of Group may be:
i) permanent, with the individuals kept part of the Group as long as the individual does not initiate a process for leaving the Group, or the manager of the Group does not expulse the individual of the Group or close the Group; or
ii) temporary, with parameters limiting the inclusion to the Group or the existence of the Group being either time-associated, geographically associated, e.g., the individual being located within a geofence, or associated activity.

It is to be noted therefore that rights and parameters associated with the Group may, for a short period or on some occasions override some rights and parameters of the individuals participating in the Group.

One should note that the notion of participating in a Group involves some kind of consent, and more precisely voluntary consent provided through actions, data or geographical movement.

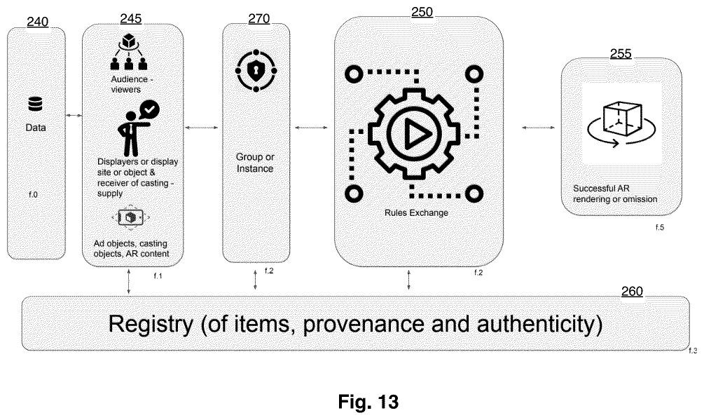

Referring to FIG. 12, the block diagram graphically depicts concepts and data involved in providing Augmented Space Ecosystem. Block 240 depicts the Register with data (rights and parameters) associated to the elements of the different Classes. Block 245 depicts elements of the three Classes to be considered when generating Augmented Spaces. Block 250 depicts the process of applying the Rules and performing AR Rendering process(es). Block 255 depicts the Augmented Spaces that are the outcomes of the AR Rendering process(es). Block 260 depicts a distinct register storing additional parameters such as provenance and authenticity associated with Virtual Assets. It is to be noted that according to embodiments, data stored in block 260 may be part of data stored in block 240, or not considered.

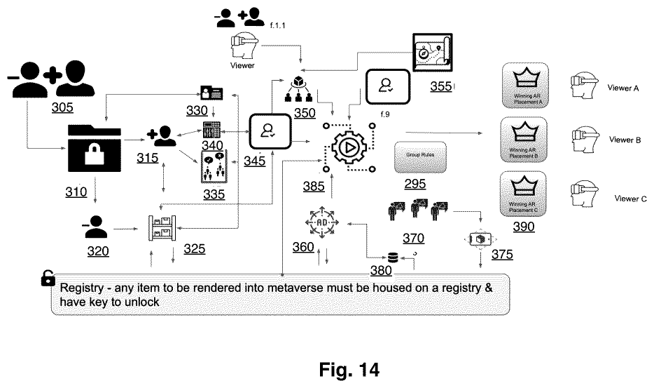

Referring to FIG. 13, the block diagram illustrates the process when Groups are considered by the system. Management of Groups depicted through Block 270, comprising associated rights and parameters, takes place between Block 245 and Block 250. It is to be noted that the notion of Group may be associated with members of any of the Classes, such as Audience Class as explained before, but also of Display Class or Asset Class.

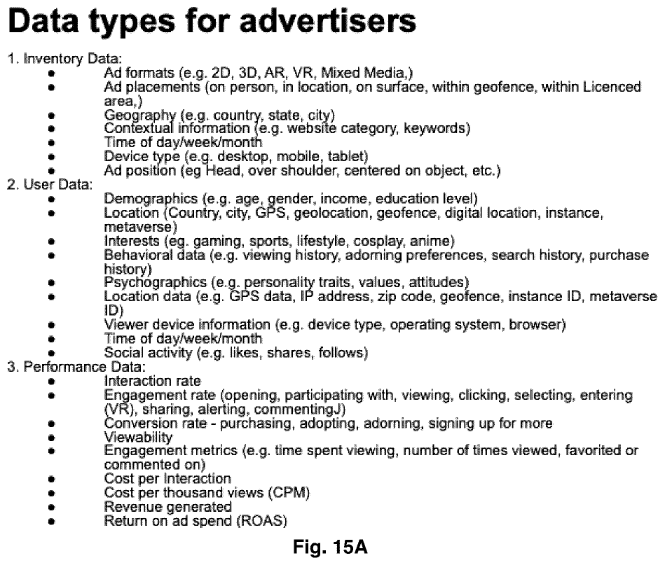

Referring to FIG. 14, the flow chart schematically depicts an exemplary data flow to feed the Rules and the Rules outcome.

It is to be noted that in a typical embodiment, any member of any of the Classes taking an active part in the Augmented Space Ecosystem must be registered in the register and have the necessary rights and identifications, e.g., key. Without such information, the element cannot be properly processed by the Operating System to take part in the Augmented Space Ecosystem.

Still referring to FIG. 14, the example is an outdoor festival that offers an AR programmatic ad opportunity where festival participants can opt into or out of an AR experience upon entering the outdoor festival. This instance or private Group has views and rules that are geofenced around the festival grounds. Those participants who enter and accept the rules get to see the AR experience and also allow the festival group preferences to potentially render onto their person (relative Overlayable Space) for display perceptible to other participants, and, additionally, render into their AR viewer. In this case, in order to see the full AR experience put on by the festival, the participants must allow advertising to be rendered. The AR Rules Engine, the software operating the Rules, manages the interaction between the audience, displays (or supply of viewers, and participants, to render onto), and the assets having advertiser demand, and all of their data sources, rules and preferences to determine what, if anything, to render for any participant or viewer within the festival.

It is to be noted that more than one AR experience may take place over the same location of an outdoor festival. Accordingly, based on the selected AR experience, two people located one beside the other may be provided with different augmented spaces. Accordingly, many layers of rights, managements, processes, etc. may be associated with a single physical location. More generally, many layers may be associated with any of the Classes, allowing highly customized augmented spaces.

Through FIG. 14, it is shown a high level overview of two different members of Audience Class: one who opts into and one who opts out of being included as a display site for advertising. Any individual can be member of the Audience Class, that is using a viewer (looking at the AR world) and a display site (member of the Display Class) (publishing AR Asset on themselves or nearby) and may allow an exchange or advertiser to push content onto them to monetize their viewership and be aggregated into the supply and demand exchange. The rules engine determines what renders for every object (member of the Asset Class), every display (member of the Display Class), and every viewer (member of Audience Class) for both individuals and groups.

More precisely, Block 305 depicts a User 1 with a ‘+’ sign that indicates that User 1 opts in and a User 2 with a ‘−’ sign that indicated that User 2 opts out.
Block 310 depicts Accounts, with User 1 and User 2 logging into their account, unlocking their owned collection of wearable AR/VR/XR members of the Asset Class.
Block 315 depicts User 1 opting into carrying a branded/paid/sponsored placement.
Block 320 depicts User 2 deciding to opt out of carrying a branded/paid/sponsored placement.
Block 325 depicts a collection of owned AR/VR/XR files, effects, shaders triggers, configuration data for sets, or in other words members of the Asset Class, rights and parameters associated therewith.
Block 330 depicts Account data, viewer preferences to be shared.
Block 335 depicts User permissions data e.g., display preferences, bid floor, group preferences, multi opt-in/out.
Block 340 depicts User Interface for customization, look mixing, configuration, settings and Go ‘Live’!
Block 345 depicts User's ‘Live’ data pack in an aggregate/Supply Side Platform (SSP).
Block 350 depicts the supply side platform for aggregating all publisher inventory and data (including data pack part of Block 340). It is worth mentioning that publishers can be anyone, anything carrying or adorning a distributed or branded AR/XR/VR object e.g., wearer, placement object, influencer, placement spot for on screen in video chat, GPS location, locale or geofenced location.
Block 355 depicts geographic data/device data.
Block 360 depicts a demand platform to aggregate all demand items to display from ad clients or caster objects.
Block (not depicted) would show depiction of a Register
Block 370 depicts clients or casters competing for inventory-data, metadata On the Demand Side Platform (DSP).
Block 375 depicts AR objects with metadata, owned or distributed by clients or casters.
Block 380 depicts Customer Relationship Management (CRM) data with audience requirements for targeting.
Block 385 depicts the Rules Engine that determines what to render to who or group in every placement and every situation.
Block 390 depicts winning AR/XR/VR placement.
Block 295 depicts the Group Rules applied to determine which placement is applicable to each Audience member of the same Group.

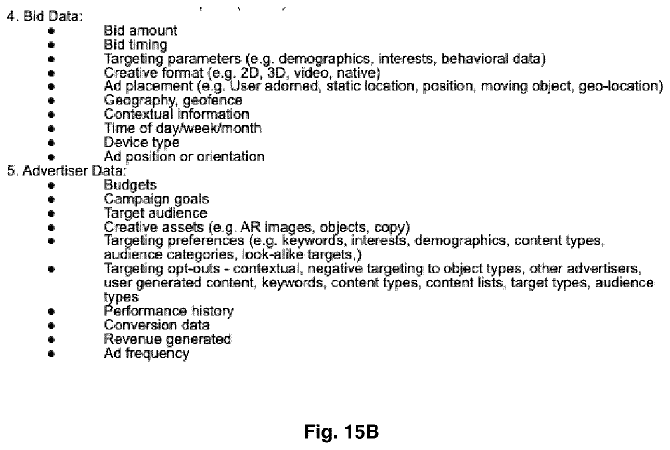

FIG. 15A and FIG. 15B depict exemplary data in relation with the block diagram of FIG. 14.

For the illustrative purpose of depicting the outcome of the AR Rendering process with the Classes, FIG. 8 still depicts a similar segmentation process based on an image capture of the physical model, for example a user, through a camera. defining thereby a member of Display Class and an Overlayable Space. The segmentation process recognizes a physical model, in the present example the user 110 and the silhouette of the user 110. In other words, the system defines a (negative) digital 3D mapping 120, so that the AR Rendering process can make objects appear in the Overlayable Space. When the camera image that provides a capture of the Physical Space is blended with the virtual assets 115, 116, 117 the software set locations for the assets to appear into the Augmented Space 185.

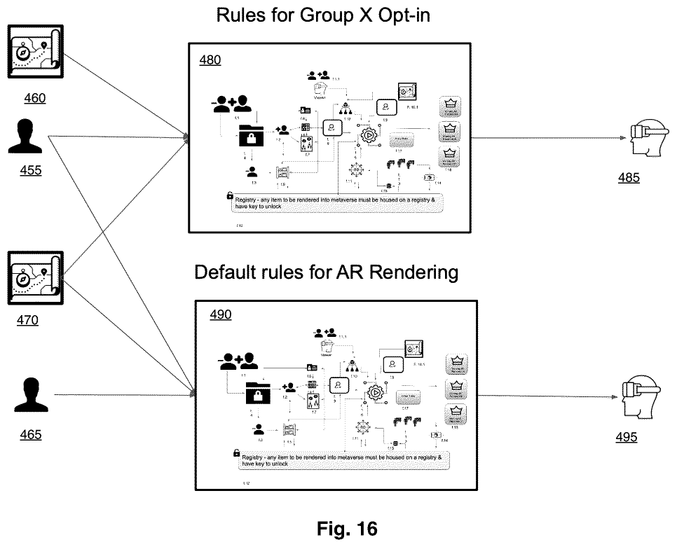

Referring now to FIG. 16, a method may be described as depicting parallel processing based on Group Rules and (opt-out) Rules with:
Block 455 depicting an individual A having provided consent to be part of a Group;
Block 460 depicting the geolocation data associated with the individual A;
Block 465 depicting an individual B having refused to provide consent, thus having opt out to be part of the same Group;
Block 470 depicting the geolocation data associated with the individual B;
Block 480 depicting the process of generating a Group Augmented Space for individual A, wherein the process is based on the information (Rules and rights) associated with the group when in the location received for the individual A;
Block 485 depicting the delivery of the Group Augmented Space to individual A, or of the virtual space and the method of depicting, depending on the technology used. If the augmented space is provided, the blending is performed by the server, and the viewer displays the Augmented Space. If the blending is performed by the viewer, the viewer receives the virtual space of the Group, and blends the virtual space and the observable physical space into the Augmented space of the group. It is the latter, the augmented space, that is perceived by the individual through the viewer;
Block 490 depicting the process of generating an Opt-out Augmented Space for individual B; and
Block 495 depicting the delivery of the Opt-out Augmented Space to individual B.
Blocks 490 and 495 are similar in many ways to Blocks 485 and 490, but differ in the specific location of the Individual B and the Rules and rights applicable to the generation of the virtual space and ultimately the Augmented space since the Rules and rights of the group do not trump the individual Rules and rights.

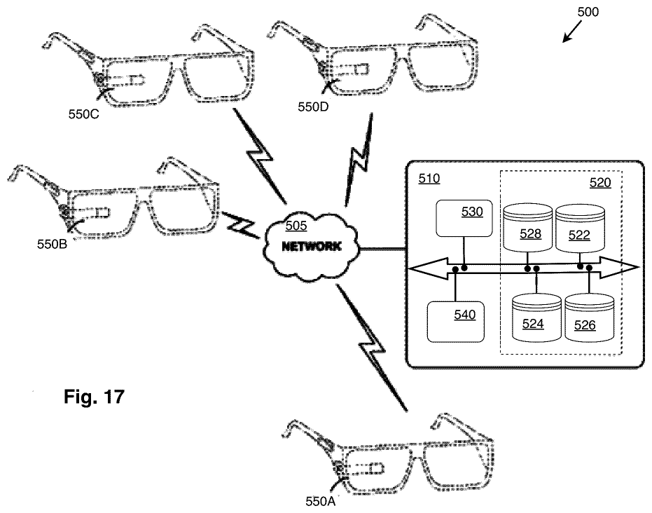

Referring to FIG. 17, a depiction of an Augmented Reality Ecosystem 500 may comprise a server 510, or a cluster of servers (illustrated through the single server) over which the operations are distributed. The server 510 comprises a memory for storing registers 522, 524, 526, and program codes 528, a processor 530 adapted to process data and perform operations based on the program codes and the data, and a communication interface component 540 for data exchange with Augmented Reality viewers 550. The Augmented Reality Viewers 550 are each associated with a different individual.

While preferred embodiments have been described above and illustrated in the accompanying drawings, it will be evident to those skilled in the art that modifications may be made without departing from this disclosure. Such modifications are considered as possible variants comprised within the scope of the disclosure.

1. A method of providing a ruled augmented reality space, the method comprising:
providing an audience class with a first audience class member having first audience class data;
providing an asset class with a first asset class member having first asset class data;
providing a display class with a first display class member having first display class data, the first display class member being located in a physical space;
providing rules applicable within the physical space;
processing the first audience class data, the first asset class data and the first display class data according to the rules to generate a first ruled virtual space; and
combining the first ruled virtual space with the physical space to generate a first ruled augmented reality space perceivable by the first audience class member.

2. The method of claim 1, further comprising displaying the first asset class member on the first display class member in the first ruled augmented reality space to be perceived by the first audience class member.

3. The method of claim 1 further comprising displaying the first ruled augmented reality space to the first audience class member through a first viewer device.

4. The method of claim 1, further comprising:
providing the asset class with a second asset class member having second asset class data;
providing the display class with a second display class member having second display class data, the second display class member being located in the physical space;
processing the second audience class data, the second asset class data and the second display class data according to the rules to generate a second ruled virtual space; and
combining the second ruled virtual space with the physical space to generate a second ruled augmented reality space perceivable by the second audience class member.

5. The method of claim 4, further comprising displaying the second asset class member on the second display class member in the second ruled augmented reality space to be perceived by the second audience class member.

6. The method of claim 4, further comprising displaying the second ruled augmented reality space to the second audience class member through a second viewer device.

7. A method of providing a ruled augmented reality space for a plurality of users in a physical space, the method comprising:
providing a first register of audience class members, each audience class member being one of the plurality of users, the first register having audience rules;
providing a second register of asset class elements, the second register having asset rules;
providing a third register of display class elements, the third register having display rules;
generating a plurality of virtual spaces using data associated with:
i) the audience class members;
ii) the asset class elements;
iii) the display class elements;
iv) the audience rules
v) the asset rules; and
vi) the display rules; and
combining each one of the plurality of virtual spaces with the physical space to produce a plurality of ruled augmented reality spaces, each one of the plurality of ruled augmented reality spaces being specifically generated to be displayed to a corresponding one audience class member.

8. The method of claim 7, further comprising:
providing a fourth register of virtual space rules;
determining if each one of the plurality of virtual spaces abide by the virtual space rules; and
preventing generating one of the plurality of ruled augmented reality spaces for those virtual spaces that do not abide by the virtual space rules.

9. The method of claim 7, further comprising registering geolocation data of each audience class member, wherein the processing is further performed based on the geolocations data.

10. The method of claim 7, further comprising displaying each one of the plurality of ruled augmented reality spaces on a corresponding one of a plurality of viewer devices worn by the corresponding one audience class member.

11. The method of claim 10, wherein the displaying is simultaneous.

12. The method of claim 10, further comprising registering orientations of viewing devices of the users, wherein the processing is further performed based on the orientations.

13. The method of claim 7, wherein at least one display class member is associated with at least one of the audience class members.

14. The method of claim 7, further comprising:
assembling into a group the audience class members, the group having a group audience rule; and
overruling at least one audience rule with the group audience rule during the generating the plurality of virtual spaces.

15. The method of claim 14, wherein the assembling into a group of a participating member of the audience members is triggered through a verbal consent from the participating member, a written consent from the participating member, or the participating member entering a geofenced area.

16. The method of claim 7, wherein the generating the plurality of virtual spaces is achieved using a server.

17. A server for providing augmented reality spaces to a plurality of users, the server comprising:
a processor; and
a memory storing:
a first register of members of an audience class, wherein at least two members are associated with the plurality of users, the first register storing audience rules therein;
a second register of elements of an asset class, the second register storing asset rules therein;
a third register of elements of a display class, the third register storing display rules therein;
processing code, that when processed, has the processor processing data associated with i) each of the members of the audience class associated with the plurality of users, ii) at least one element of the asset class, and iii) at least one element of the display class, and generating a plurality of virtual spaces;
and
a communication interface
for receiving identification of the plurality of users from augmented reality viewer devices under control of the plurality of users; and
for transmitting one of the plurality of virtual spaces to each of the augmented reality viewer devices for the augmented reality viewer devices to provide to the user one of the augmented reality spaces, wherein each one of the augmented reality spaces is specific to each one of the plurality of users.

18. The server of claim 17, further comprising a plurality of server units interconnected through a network, wherein at least one of the provided registers and at least one of the processes performed are distributed over at least two of the plurality of server units.
